(19) United States
(12) Patent Application Publication
(10) Pub. No.: US 2026/0203658 A1
(43) Pub. Date: Jul. 16, 2026

(54) ELECTRONIC DEVICE AND OPERATING METHOD THEREOF

(71) Applicant: Samsung Electronics Co., Ltd., Suwon-si (KR)

(72) Inventors: Minseok KIM, Suwon-si (KR); Gilhwan KIM, Suwon-si (KR); Sangbeom PARK, Suwon-si (KR); Junhyeok PARK, Suwon-si (KR); Yoonsang LEE, Suwon-si (KR); Yohwan JOO, Suwon-si (KR); Ahryeon CHOI, Suwon-si (KR); Sangmin HWANG, Suwon-si (KR)

(21) Appl. No.: 19/299,223

(22) Filed: Aug. 13, 2025

(30) Foreign Application Priority Data
Jan. 14, 2025 (KR) 10-2025-0005664

(51) Int. Cl. G06N 20/00

(52) U.S. Cl. CPC G06N 20/00

(57) ABSTRACT

The present disclosure relates to an electronic device, including a communication circuit, at least one processor, and a memory. The memory stores instructions, when executed by the at least one processor, which cause the electronic device to obtain operation data associated with operations of a plurality of assemblies of a semiconductor exposure device in an exposure process for a wafer, through the communication circuit, identify a loss operation associated with data loss based on the operation data, generate a restoration model configured to restore the loss operation based on the operation data, and obtain restoration operation data associated with the loss operation based on the restoration model.

### CROSS-REFERENCE TO RELATED APPLICATION

This application claims priority under 35 U.S.C. § 119 to Korean Patent Application No. 10-2025-0005664, filed on Jan. 14, 2025, in the Korean Intellectual Property Office, the entire contents of which are hereby incorporated by reference.

### BACKGROUND

### Field

The present disclosure relates to an electronic device and a method of operating the electronic device.

### Description of Related Art

Recently, as extreme ultraviolet EUV exposure technology has been developed as one of the semiconductor exposure technologies, the introduction of EUV exposure equipment is increasing. EUV exposure technology is a technology that uses a light source with an extreme ultraviolet wavelength in the exposure process, enabling the formation of high-precision semiconductor patterns.

As the introduction of EUV exposure equipment expands, the need for technology to quickly analyze the causes of operational delays that may occur in exposure equipment is increasing. EUV exposure equipment performs complex processes using extreme ultraviolet light, requiring precise interaction between various assemblies and modules. Accordingly, systematic analysis of the cause of operation delay and technology for maintaining the normal operation pattern of the equipment may contribute to improving the stability and productivity of EUV exposure equipment.

The above-described information is intended to enhance understanding of the background of the present disclosure and may include information that does not constitute prior art.

### SUMMARY

The present disclosure relates to an electronic device and an operating method of the electronic device for solving the above problems.

The problems to be solved by the present disclosure are not limited to those described above, and other problems not mentioned may be clearly understood by those skilled in the art from the description of the disclosure below.

According to some aspects, an electronic device may include a communication circuit, at least one processor, and a memory. The memory may store instructions, when executed by the at least one processor, which cause the electronic device to obtain operation data associated with operations of a plurality of assemblies of a semiconductor exposure device in an exposure process for a wafer, through the communication circuit, identify a loss operation associated with data loss based on the operation data, generate a restoration model configured to restore the loss operation based on the operation data, and obtain restoration operation data associated with the loss operation based on the restoration model.

According to some aspects, an electronic device may include a communication circuit, at least one processor, and a memory. The memory may further store instructions, when executed by the at least one processor, which cause the electronic device to obtain operation data associated with operations of a plurality of assemblies of a semiconductor exposure device in an exposure process for a wafer, through the communication circuit, obtain abnormal operation data based on the operation data, generate a cause analysis model configured to identify a cause of abnormal operations for the plurality of assemblies based on the abnormal operation data, output at least a part of the abnormal operation data, receive feedback data associated with the abnormal operation data, and train the cause analysis model based on the abnormal operation data and the received feedback data.

According to some aspects, a method of operating an electronic device may include obtaining operation data associated with operations of a plurality of assemblies of a semiconductor exposure device in an exposure process for a wafer through the communication circuit, generating restoration operation data by restoring lost data based on the operation data, obtaining abnormal operation data based on the restoration operation data, and generating a cause analysis model configured to identify a cause of abnormal operations for the plurality of assemblies based on the abnormal operation data, in which the generating of the restoration operation data may include identifying a loss operation associated with data loss based on the operation data, generating a restoration model configured to restore the loss operation based on the operation data, and obtaining restoration operation data associated with the loss operation based on the restoration model.

According to various embodiments of the present disclosure, an electronic device may identify a loss operation in which data loss has occurred among acquired operation data, and restore operation data associated with the loss operation by recovering the operation data through a restoration model. Through this configuration, the process of creating a cause analysis model and analyzing motion delay may be performed effectively by utilizing the restored operation data. Additionally, the reliability and accuracy of analysis of causes of motion delay may be improved.

According to various embodiments of the present disclosure, data of various domains are comprehensively analyzed through a restoration model of a multi-modal structure, so that missing portions of operation data of a semiconductor exposure device may be effectively restored. Through this, the restored operation data may be utilized to analyze the cause of equipment operation, and the cause of abnormal operation may be effectively analyzed.

According to various embodiments of the present disclosure, a user's domain knowledge may be reflected in the model training process through a continuous feedback process, thereby building an advanced model that may be flexibly applied to equipment and equipment models.

According to various embodiments of the present disclosure, even when new equipment is introduced, the existing model may be improved with only minimal additional training, such as fine-tuning, based on the existing model. This enables rapid response when changing facilities or introducing new facilities, and development time and costs may be effectively reduced.

The effects that may be obtained through the present disclosure are not limited to those described above. Any technical effects not mentioned will be clearly understood by those skilled in the art from the description of the disclosure set forth below.

### BRIEF DESCRIPTION OF THE DRAWINGS

FIG. 1 is a drawing for explaining an electronic device according to some example embodiments of the present disclosure.

FIG. 2 is a drawing for explaining a semiconductor exposure device according to some example embodiments of the present disclosure.

FIG. 3 is a drawing for explaining a detailed configuration of an electronic device according to some example embodiments of the present disclosure.

FIG. 4 is a drawing for explaining a detailed configuration of a restoration operation data generation unit according to some example embodiments of the present disclosure.

FIG. 5 is a diagram illustrating an exemplary process for obtaining restoration operation data.

FIG. 6 is a diagram illustrating an exemplary process in which a loss operation is identified in operation data.

FIGS. 7 and 8 are diagrams for explaining an exemplary process in which a restoration model is learned.

FIG. 9 is a diagram illustrating an exemplary process for obtaining restoration operation data through a restoration model.

FIG. 10 is a diagram illustrating an exemplary process for obtaining abnormal operation data.

FIGS. 11 and 12 are diagrams for explaining an exemplary process in which a cause analysis model is generated based on abnormal operation data.

FIG. 13 is a flowchart illustrating an example of a method of operating an electronic device according to some example embodiments of the present disclosure.

FIG. 14 is a drawing for explaining an example of a computer device in which an electronic device is implemented according to some example embodiments of the present disclosure.

### DETAILED DESCRIPTION

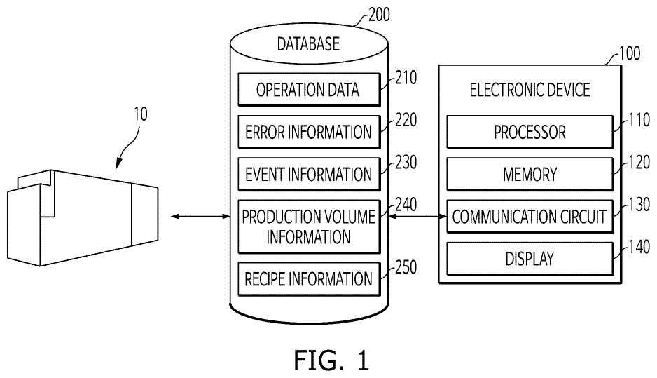

Hereinafter, various embodiments of the present disclosure will be described with reference to FIGS. 1 to 14. Throughout the specification, the same reference numerals refer to the same components.

FIG. 1 is a drawing for explaining an electronic device according to some example embodiments of the present disclosure.

Referring to FIG. 1, an electronic device 100 according to one embodiment may include a processor 110, a memory 120, a communication circuit 130, and a display 140. An electronic device 100 may access data stored in a database 200 or record data in the database 200 through a communication circuit 130. In some embodiments, the electronic device 100 may omit one or more of the components described above (e.g., the display 140) or may additionally include other components (e.g., an input device). Additionally, although the processor 110 in FIG. 1 is depicted as a single processor 110, the scope of the present disclosure is not limited thereto. For example, the processor 110 may include one or more processors.

The processor 110 may be a central processing unit (CPU) chip, a graphic processing unit (GPU) chip, an application processor (AP) chip, an application specific integrated circuit (ASIC), or other processing chips. The processor 110 may be electrically connected to the memory 120, the communication circuit 130, and the display 140. The processor 110 may control the operations of the electronic device 100 by controlling at least one component that is connected to the processor 110 and constitutes the electronic device 100.

The processor 110 may execute instructions stored in the memory 120. The processor 110 may control at least one component constituting the electronic device 100 by executing instructions stored in the memory 120. Instructions may be provided to the processor 110 from the memory 120 and/or the communication circuit 130. Hereinafter, the operations described as being performed by the processor 110 may be performed by the processor 110 and/or at least one component connected to the processor 110 and constituting the electronic device 100, and thus may be understood to be performed by the electronic device 100.

The processor 110 may receive data related to the semiconductor exposure device 10 from the database 200 through the communication circuit 130. In some embodiments, data associated with the semiconductor exposure device 10 may include operation data 210 associated with the operation of a plurality of assemblies included in the semiconductor exposure device 10 in an exposure process for a wafer. Here, the operation data 210 may include, but is not limited to, the name of the assembly, the operation name, the operation start time, the operation end time, wafer information, etc. In some embodiments, the operation data 210 may be collected in the database 200 according to the order in which the plurality of assemblies performed the operations. Accordingly, the processor 110 may receive the operation data 210 collected in the database 200 in real time, aperiodically (e.g., irregularly) or periodically through the communication circuit 130. For example, the processor 110 may receive the operation data 210 collected in the database 200 in real time at predetermined intervals through the communication circuit 130.

Additionally, each of the plurality of assemblies included in the semiconductor exposure device 10 may be understood as a combination of components for performing a specific function in the exposure process. For example, the plurality of assemblies may include a light source assembly, a load lock assembly, a vacuum pump assembly, a reticle alignment assembly, a stage alignment assembly, a load robot assembly, and the like. However, the present disclosure is not limited thereto, and the classification criteria for the assembly may be variously defined according to device design, functional role, process requirements, etc. Each of the plurality of assemblies may transmit operation data 210 to the database 200 after performing an operation.

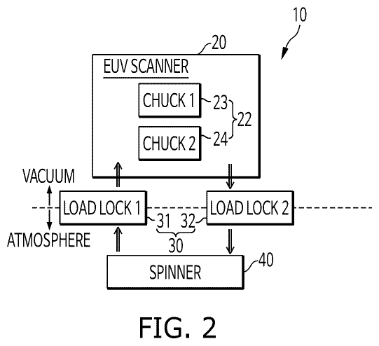

The semiconductor exposure device 10 may be, for example, an extreme ultraviolet (EUV) device that performs an exposure process using a light source of extreme ultraviolet wavelength. The exposure process using an EUV device may include an exposure process for each wafer, a chuck swap process between the wafer and the subsequent wafer, and/or a reticle alignment process. Additionally, the exposure process by the EUV device may further include a reticle exchange process, in addition to the chuck swap process and reticle alignment process performed between the process for the last wafer of a preceding lot and the process for the first wafer of a subsequent lot. The exposure process using the EUV device is described in detail in FIG. 2.

The database 200 may store data associated with the semiconductor exposure device 10. Data associated with a semiconductor exposure device 10 may include all data associated with an exposure process for a wafer performed by the semiconductor exposure device 10.

In some embodiments, data associated with a semiconductor exposure device 10 may include operation data 210 associated with the operation of a plurality of assemblies included in the semiconductor exposure device 10 in an exposure process for a wafer.

In some embodiments, data associated with the semiconductor exposure device 10 may further include at least one of error information 220, event information 230, production volume information 240, and recipe information 250. The error information 220 may include information about code recorded when a delay of an assembly operation, or an abnormal operation occurs. The event information 230 may include log data regarding abnormal system situations such as equipment failure or continued IDLE status. The production volume information 240 may include detailed data related to wafers, such as wafer information, wafer slot order, lot size, wafer swap time WST, shot count, reticle information, and device information. The recipe information 250 may include information on setting values applied to each assembly of a semiconductor exposure device 10 in an exposure process. For example, the recipe information 250 may include information on working variables such as the dose of light irradiated onto the wafer, the intensity of the light, or the temperature maintained during the exposure process.

In some embodiments, at least one of the error information 220 and the event information 230 may be stored in the database 200 in the form of data sequentially recorded according to the time flow from immediately after the wafer is inserted into the semiconductor exposure device 10 until all operations associated with the exposure process are completed. In the present disclosure, time-series data in this manner may be referred to as a first type of data. Therefore, the first type of data may be data associated with an operation event for a plurality of assemblies.

In some embodiments, at least one of the production volume information 240 or the recipe information 250 may be stored in the database 200 in a table format consisting of a plurality of rows and columns. Here, each row corresponds to an individual wafer, and each column may represent detailed information related to the wafer. In the present disclosure, such table-like data may be referred to as a second type of data. Therefore, the second type of data may be data associated with the execution of the exposure process. However, the embodiment is not limited to this example, and each data may be converted or utilized in different forms. For example, data related to operation events for a plurality of assemblies may be organized in a table format, or data related to the execution of an exposure process may be stored in a database 200 as time series data.

Data stored in the database 200 may be transmitted to the electronic device 100 through the communication circuit 130 of the electronic device 100.

The memory 120 may include any electronic component capable of storing electronic information. For example, the memory 120 may refer to various types of processor-readable media, such as random access memory RAM, read-only memory ROM, nonvolatile random access memory NVRAM, programmable read-only memory PROM, erasable-programmable read-only memory EPROM, electrically erasable PROM EEPROM, flash memory, magnetic or optical data storage devices, disk drives, solid state drives SSDs, registers, and the like. In one example, a non-volatile mass storage device such as a ROM, SSD, flash memory, disk drive, etc., may be included in the electronic device 100 as a separate persistent storage device distinct from the memory 120.

The memory 120 may store data used by at least one component (e.g., a processor 110 or a communication circuit 130) of the electronic device 100. For example, the memory 120 may store instructions executed by the processor 110. As another example, the memory 120 may store data transmitted and received through the communication circuit 130. Specifically, the memory 120 may store data associated with the semiconductor exposure device 10 received from the database 200 via the communication circuit 130.

In addition, the memory 120 may store an operating system and at least one program code including one or more instructions (e.g., code for obtaining operation data of a semiconductor exposure device 10, obtaining abnormal operation data, generating a cause analysis model, etc.). In one example, these software components may be loaded from a computer-readable recording medium separate from the memory 120. In another example, software components may be loaded into the memory 120 via the communication circuit 130 rather than a computer-readable recording medium. For example, at least one program code may be loaded into the memory 120 based on a computer program that is installed by files provided over a network by developers or a file distribution system that distributes installation files for the application.

The communication circuit 130 may communicate with an external device via a wired or wireless communication network. For example, the communication circuit 130 may perform a communication connection between the electronic device 100 and the database 200. The electronic device 100 may receive data stored in the database 200 through the communication circuit 130. For example, the communications circuit 130 may be a communications interface that provides wireless and/or wire line digital and/or analog interface to one or more networks over one or more network connections (not shown), thereby allowing the electronic device to transmit and/or receive data and/or instructions to and/or from the database 200.

The display 140 may visually provide various information to a user (e.g., an engineer) of the electronic device 100. The display 140 may output data processed by the processor 110. For example, the display 140 may output at least a part of the abnormal operation data acquired by the processor 110. Here, abnormal operation data may refer to data identified as abnormal operation among the operation data of the semiconductor exposure device 10.

The display 140 may include, for example, a touch screen and may receive touch, gesture, proximity, or hovering input using an electronic pen or a part of the user's body. In this case, the display 140 may also be used as an input device, but the embodiment is not limited to this example. In some embodiments, the electronic device 100 may further include a separate input device.

FIG. 2 is a drawing for explaining a semiconductor exposure device according to some example embodiments of the present disclosure.

In some embodiments, the semiconductor exposure device 10 may be a device that performs EUV exposure on a wafer. Referring to FIG. 2, a semiconductor exposure device 10 according to one embodiment may include an EUV scanner 20 and a load lock chamber 30. Although not shown, the semiconductor exposure device 10 may further include components for performing EUV exposure. For example, the semiconductor exposure device 10 may further include a loading robot, an unloading robot, etc.

The load lock chamber 30 may be a chamber that functions as a passage for supplying a wafer from a spinner 40 to an EUV scanner 20 or discharging the wafer from the EUV scanner 20. The load lock chamber 30 is positioned and coupled to the inlet and/or outlet of the EUV scanner 20 and may be maintained in an atmosphere or vacuum state. Here, the wafer may mean a semiconductor substrate on which an EUV photolithography process, such as EUV exposure, is performed to form a circuit pattern. However, the wafer is not limited to a semiconductor substrate and may refer to any type of substrate on which EUV exposure may be performed.

To briefly explain the process of inputting and outputting a wafer through the load lock chamber 30, first, the wafer is moved from the spinner 40 to the first load lock chamber 31 by a loading robot in a state that the load lock chamber 30 is maintained at an atmospheric pressure. Thereafter, the load lock chamber 30 is evacuated by a vacuum pump, and the wafer is moved to a chuck table 22 within the EUV scanner 20 by a stage loading robot. Afterwards, EUV exposure to the wafer may be performed by the EUV scanner 20. After EUV exposure is performed by the EUV scanner 20, the wafer is moved to a second load lock chamber 32 in a vacuum state by a stage unloading robot. Thereafter, the load lock chamber 30 is switched to atmospheric pressure, and the wafer is moved back to the spinner 40 by the unloading robot.

As illustrated, the load lock chamber 30 may include a first load lock chamber 31 and a second load lock chamber 32. The first load lock chamber 31 may be coupled to the inlet side of the EUV scanner 20, and the second load lock chamber 32 may be coupled to the outlet side of the EUV scanner 20. Accordingly, the wafer may be supplied to the EUV scanner 20 through the first load lock chamber 31, and the wafer may be discharged from the EUV scanner 20 through the second load lock chamber 32. In some cases, a semiconductor exposure device 10 may have only one load lock chamber 30. In such a case, the supply and discharge of wafers may be performed alternately in one load lock chamber 30.

A spinner 40 may refer to a device that performs a photoresist PR coating process, a developing process, or an etching process on a wafer. In some embodiments, the spinner 40 may also be referred to as a track.

The chuck table 22 may include a first chuck table 23 and a second chuck table 24. The first chuck table 23 may be a chuck table used for the exposure process, and the second chuck table 24 may be a chuck table for waiting for a subsequent process. The exposure process is performed by exchanging two chuck tables 23 and 24, and also, as loading/unloading of wafers to/from the chuck tables is performed, the EUV exposure process may proceed quickly. Here, the number of chuck tables 22 is not limited to two. For example, only one chuck table 22 may be provided, or three or more chuck tables 22 may be provided.

In some embodiments, each of the components of the semiconductor exposure device 10 mentioned through the description of FIG. 2 may constitute a plurality of assemblies of the semiconductor exposure device 10. For example, the first load lock chamber 31 may constitute at least a part of the first load lock assembly, and the second load lock chamber 32 may constitute at least a part of the second load lock assembly. Additionally, the EUV scanner 20 may constitute at least a part of the light source assembly, the loading robot may constitute at least a part of the load robot assembly, and the unloading robot may constitute at least a part of the unloading robot assembly.

In FIG. 2, only some components of the semiconductor exposure device 10 are briefly illustrated for convenience of explanation, but the embodiment is not limited to this example. For example, the semiconductor exposure device 10 may further include additional components, and at least some of the illustrated components may further include detailed components. Additionally, each of the added components may constitute a plurality of assemblies of the semiconductor exposure device 10.

Further, the components of the semiconductor exposure device 10 operate organically and may perform an exposure process on a wafer through interaction. In this process, if the operation flow between components is not smooth, such as when the interval between the operations of each component increases or abnormal delays occur, the efficiency of the entire process may decrease, resulting in a decrease in production. In particular, the operation data required to analyze the cause of such delays and derive improvements may be lost or omitted for various reasons, such as being omitted during the data collection process, being black-boxed by the manufacturer, or disabling data logging options to prevent equipment performance degradation. This has led to the suggestion of a method for analyzing the cause of operation delay without using operation data, but this has low reliability in the analysis results and may consume excessive time and cost in the process of developing and maintaining the method.

According to various embodiments of the present disclosure, an electronic device (e.g., electronic device 100 of FIG. 1) may identify a loss operation in which data loss has occurred among acquired operation data, and restore operation data associated with the loss operation by recovering the operation through a restoration model. Through this configuration, the process of creating a cause analysis model and analyzing operation delay may be performed effectively by utilizing restored operation data. Additionally, the reliability and accuracy of analysis of causes of operation delay may be improved.

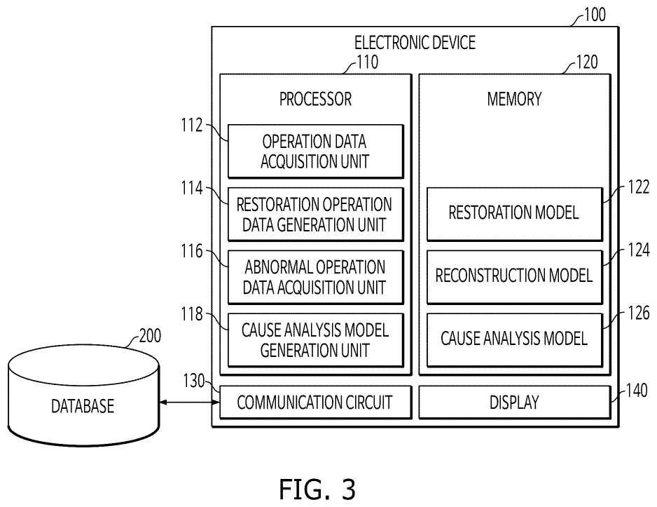

FIG. 3 is a drawing for explaining a detailed configuration of an electronic device according to some embodiments of the present disclosure. In the following, any explanation that overlaps with the above description is omitted or briefly described.

Referring to FIG. 3, a processor 110 according to one embodiment may include an operation data acquisition unit 112, a restoration operation data generation unit 114, an abnormal operation data acquisition unit 116, and a cause analysis model generation unit 118. Additionally, the memory 120 according to one embodiment may store a restoration model 122, a reconstruction model 124, and a cause analysis model 126.

Those skilled in the art will appreciate that each of the operation data acquisition unit 112, the restoration operation data generation unit 114, the abnormal operation data acquisition unit 116, and the cause analysis model generation unit 118 and their components are physically implemented by the processor 110. For example, each of the operation data acquisition unit 112, the restoration operation data generation unit 114, the abnormal operation data acquisition unit 116, and the cause analysis model generation unit 118 may be programmed using software (e.g., microcode) to perform various functions discussed herein and may optionally be driven by firmware and/or software.

The operation data acquisition unit 112 may acquire operation data of a semiconductor exposure device (e.g., semiconductor exposure device 10 of FIG. 1) by communicating with a database 200 through a communication circuit 130. Here, the operation data may be associated with the operation of a plurality of assemblies included in a semiconductor exposure device in an exposure process for a wafer. For example, the operation data may include, but is not limited to, the name of the assembly, the operation name, the operation start time, the operation end time, wafer information, etc. The operation data may be collected and stored in a database 200 from the time the wafer is inserted into the semiconductor exposure device until the time when the operation of the entire assembly included in the semiconductor exposure device is completed. In some embodiments, the operation data acquisition unit 112 may receive operation data organized in a table format according to the order of the performed operations.

Additionally, the operation data acquisition unit 112 may acquire at least one of error information, event information, production volume information, and recipe information by communicating with the database 200 through the communication circuit 130. In some embodiments, the operation data acquisition unit 112 may acquire at least one of error information and event information in the form of time series data. In some embodiments, the operation data acquisition unit 112 may acquire at least one of production volume information and recipe information in the form of table data.

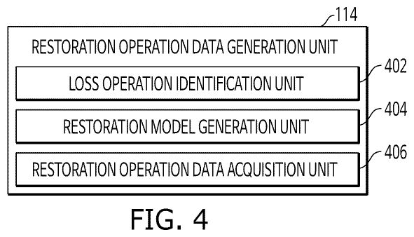

The restoration operation data generation unit 114 may generate restoration operation data by restoring lost data based on operation data. In some embodiments, the restoration operation data generation unit 114 may identify a loss operation in which data loss has occurred based on operation data, generate a restoration model 122 for restoring the loss operation based on the operation data, and obtain restoration operation data associated with the loss operation using the restoration model 122. A specific description related to this will be described later with reference to FIGS. 4 to 9. The restoration model 122 is stored in memory 120 and may be used to generate restoration operation data or additionally learned based on the operation data.

The abnormal operation data acquisition unit 116 may acquire abnormal operation data based on restored operation data. Here, abnormal operation data may mean data identified as occurrence of an abnormal operation in the exposure process for a unit wafer among operation data for a semiconductor exposure device. For example, abnormal behavior occurring in the exposure process for a unit wafer may refer to phenomena such as an increase in the operating interval between components of a semiconductor exposure device or the occurrence of abnormal delays.

In some embodiments, when performing the operation of the abnormal operation data acquisition unit 116, a reconstruction model 124 stored in the memory 120 may be utilized. For example, the abnormal operation data acquisition unit 116 may obtain reconstructed operation data by applying the restored operation data to the reconstruction model 124, and classify the abnormal operation data and normal operation data based on the reconstructed operation data.

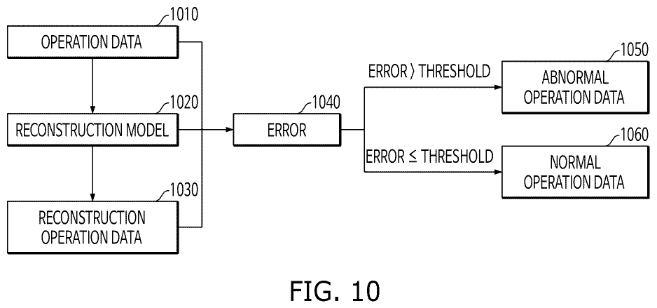

The operation data used in the abnormal operation data acquisition unit 116 may include non-loss operation data in which a loss operation is identified as not existing and restoration operation data in which a loss operation is identified but data restoration is performed. For example, in the abnormal operation data acquisition unit 116, complete data, in which no loss operation exists or missing data is restored, may be used. A specific description of the acquisition of abnormal operation data is provided below with reference to FIG. 10.

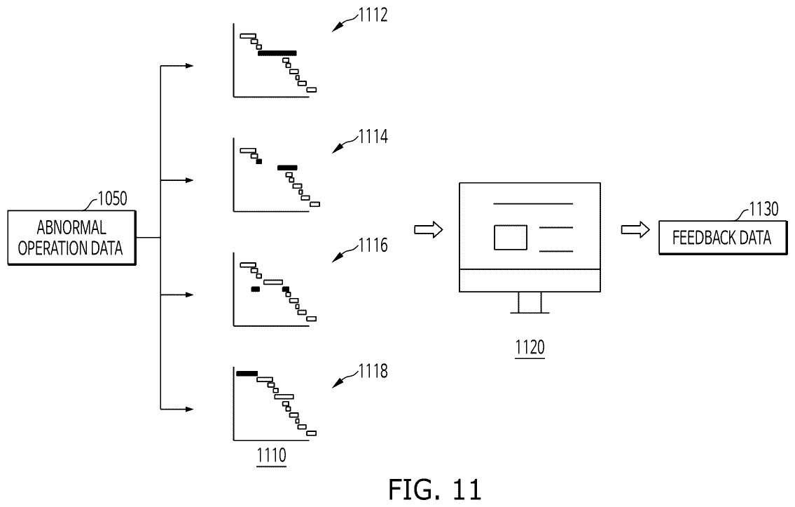

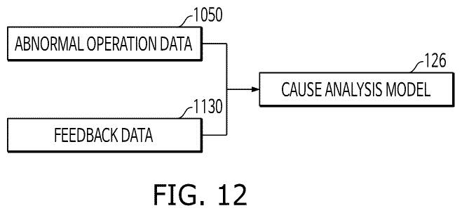

The cause analysis model generation unit 118 may generate a cause analysis model 126 based on abnormal operation data. The cause analysis model 126 generated by the cause analysis model generation unit 118 is stored in the memory 120 and may be used to identify the cause of abnormal operation of a semiconductor exposure device or may be additionally learned based on feedback data. The feedback data may include information about the cause of the abnormal operation data. In some embodiments, the cause analysis model generation unit 118 may output at least a part of the abnormal operation data through the display 140, and receive feedback data on the output abnormal operation data through the display 140 and/or a separate input device. A detailed explanation related to the analysis of the cause of the abnormal operation is described below with reference to FIGS. 11 and 12.

In some embodiments, the operation data acquisition unit 112, the restoration operation data generation unit 114, the abnormal operation data acquisition unit 116, and the cause analysis model generation unit 118 included in the processor 110 may share data (e.g., operation data, abnormal operation data, etc.) to perform the operations described above. In addition, in FIG. 3, the internal components (e.g., the operation data acquisition unit 112, the restoration operation data generation unit 114, the abnormal operation data acquisition unit 116, and the cause analysis model generation unit 118) of the processor 110 are illustrated as being separated, but this is only for convenience of explanation and does not necessarily mean that the internal components (e.g., the operation data acquisition unit 112, the restoration operation data generation unit 114, the abnormal operation data acquisition unit 116, and the cause analysis model generation unit 118) of the processor 110 are physically separated.

FIG. 4 is a drawing for explaining a detailed configuration of a restoration operation data generation unit according to some example embodiments of the present disclosure. In the following, any explanation that overlaps with the above description is omitted or briefly described.

Referring to FIG. 4, the restoration operation data generation unit 114 may include a loss operation identification unit 402, a restoration model generation unit 404, and a restoration operation data acquisition unit 406.

The loss operation identification unit 402 may identify a loss operation that has caused data loss based on operation data. The operation data may be transmitted to the loss operation identification unit 402 in the form of a table organized in the time order in which a plurality of assemblies of the semiconductor exposure device completed their operations.

In some embodiments, the loss operation identification unit 402 may obtain wafer operation data classified on a wafer-by-wafer basis based on the operation data. When an exposure process is performed by a semiconductor exposure device, exposure processes for a plurality of wafers are performed in parallel, so in order to identify whether data associated with at least one assembly is lost in the exposure process of a specific wafer, the loss operation identification unit 402 may classify the operation data in wafer units.

Additionally, the loss operation identification unit 402 may identify a loss operation and/or loss operation data according to a wafer based on the acquired wafer operation data. Here, the loss operation may mean an operation, in which an exposure process is performed by at least one assembly, but data associated therewith is not acquired. Additionally, loss operation data may mean data corresponding to a loss operation. There are many reasons why data may not be acquired, including being missed during the data collection process, being black-boxed by the manufacturer, and disabling data recording options to prevent equipment performance degradation.

In some embodiments, the loss operation identification unit 402 may classify the operation data according to individual wafers, based on wafer information (e.g., wafer identification information) included in the operation data. Thereafter, the loss operation identification unit 402 analyzes the classified wafer operation data and checks the operation log for each assembly of each wafer to identify whether data associated with a specific assembly is missing. The loss operation identification unit 402 may classify data identified as having a loss operation among wafer operation data as loss operation data, and classify data identified as not having a loss operation as non-loss operation data.

The restoration model generation unit 404 may generate a restoration model for restoring loss operation based on operation data. To this end, the restoration model generation unit 404 may obtain operation data including loss operation data and non-loss operation data. Additionally, the restoration model generation unit 404 may obtain at least one of error information, event information, production volume information, and recipe information. Here, at least one of the error information and the event information may be transmitted to the restoration model generation unit 404 in the form of time series data. Additionally, at least one of the production volume information and the recipe information may be transmitted to the restoration model generation unit 404 in the form of table data. As described above, time series data may be referred to as the first type of data, and table data may be referred to as the second type of data.

The restoration model generation unit 404 may classify operation data by assemblies, and obtain assembly operation data for each of a plurality of assemblies. For example, the restoration model generation unit 404 may classify the first assembly operation data associated with the first assembly and the second assembly operation data associated with the second assembly, respectively, based on assembly information (e.g., assembly name) included in the operation data. As needed, the restoration model generation unit 404 may convert each assembly operation data into a time series in a chronological order in order to use it for training the restoration model.

The restoration model generation unit 404 may train the restoration model by analyzing the correlation between the first type of data, the second type of data, and the non-loss operation data. For example, the restoration model generation unit 404 may train a restoration model to restore missing data of loss operation data by using the correlation between the first type of data, the second type of data, and the non-loss operation data. Since non-loss operation data is utilized to train the restoration model, the restoration model may learn complete data without any loss, and thus the restoration model may accurately and reliably restore missing data. Additionally, the loss operation data may be used to train a restoration model to learn the pattern in which the loss operation occurs.

The restoration model generation unit 404 may analyze at least one of the correlation between the first type of data and the assembly operation data, the correlation between the second type of data and the assembly operation data, and the correlation between the first assembly operation data and the second assembly operation data, and train the restoration model based on the analyzed at least one correlation.

In some embodiments, the first type of data (e.g., error information or event information) includes time series data, and may be closely related to the operation data. For example, if an error code recorded at a particular time correlates with a preceding event code, the error may be correlated with data loss that occurred later. Additionally, if the event code indicates a change in equipment status or an interruption in operation, data loss during the time period in which these events occurred may be correlated with an abnormal condition of the equipment. A restoration model may be trained to predict and restore missing data by analyzing the correlation between operation data and these time-series data.

In some embodiments, the second type of data (e.g., production volume information or recipe information) includes quantitative data and may be closely related to the operation data. For example, if a particular recipe has a higher “Dose Level” value, that value may indicate a longer exposure time on average, from which a correlation with the lost time interval may be inferred. Additionally, if a decrease in production is observed during a particular assembly interval, this may be correlated with abnormal operation or data loss in that interval. A restoration model may be trained to predict and restore missing data by analyzing the correlation between operation data and such quantitative data.

In some embodiments, inter-assembly operation data may be important information for analyzing correlations and restoring lost data through temporal and functional continuity. For example, if the operation completion time of the first assembly and the operation start time of the second assembly are related in a set pattern, even if the data of the first assembly is lost, the missing data may be restored based on the operation data of the second assembly. Additionally, the accuracy of the restoration model may be improved by supplementing missing data by referencing data from other assemblies performed under the same working conditions. The restoration model may be trained to predict and restore missing data by analyzing the correlation between these operation data.

In some embodiments, the restoration model may be implemented as a generative AI model with a multi-modal structure designed to handle data from different domains, such as time series data and table data. The restoration model is a combination of the encoder-decoder structure and the generative model, and may be optimized to reflect the characteristics of the input data.

For example, time series data is processed through an encoder based on long short-term memory LSTM, which allows the restoration model to learn temporal continuity and effectively extract meaningful patterns from the flow of data. Additionally, table data is processed through an encoder based on multilayer perceptron MLP, which enables the restoration model to effectively learn quantitative relationships in data with a standardized structure. The outputs of these two encoders may be combined in a fusion space, providing a basis for integrated analysis of interactions between different data types. The combined output is used as an input to a variational autoencoder VAE, through which high-dimensional features necessary for data restoration and anomaly detection may be learned.

According to various embodiments of the present disclosure, data of various domains are comprehensively analyzed through a restoration model of a multi-modal structure, so that missing portions of operation data of a semiconductor exposure device may be effectively restored. Through this, the restored operation data may be utilized to analyze the cause of equipment operation, and the cause of abnormal operation may be effectively analyzed. In addition, even if an abnormal operation occurs, immediate response is possible, and the overall productivity of the semiconductor exposure device may be improved.

The restoration operation data acquisition unit 406 may acquire restoration operation data associated with a loss operation using a learned restoration model. For example, if loss operation data is provided as input, the restoration model may predict or identify missing parts of the loss operation data and supplement them to output restored operation data. As described above, the restoration model may include a generative AI model configured to generate restoration operation data by restoring loss operations.

In some embodiments, the loss operation identification unit 402, the restoration model generation unit 404, and the restoration operation data acquisition unit 406 included in the restoration operation data generation unit 114 may share data (e.g., loss operation data, non-loss operation data, restoration model, etc.) to perform the operations described above. In addition, in FIG. 4, the internal components (e.g., the loss operation identification unit 402, the restoration model generation unit 404, and the restoration operation data acquisition unit 406) of the restoration operation data generation unit 114 are illustrated separately, but this is only for convenience of explanation and does not necessarily mean that the internal components (e.g., the loss operation identification unit 402, the restoration model generation unit 404, and the restoration operation data acquisition unit 406) of the restoration operation data generation unit 114 are physically separated.

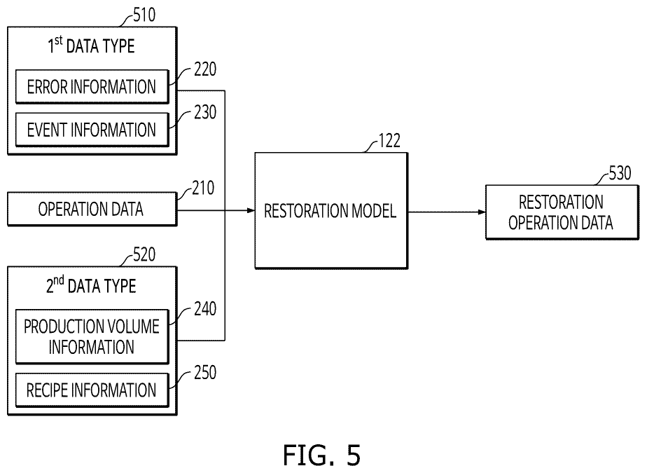

FIG. 5 is a diagram illustrating an exemplary process for obtaining restoration operation data. In the following, any explanation that overlaps with the above description is omitted or briefly described.

Referring to FIG. 5, in order to learn a restoration model 122, first type of data 510, second type of data 520, and operation data 210 may be provided. The first type of data 510 may include error information 220 and event information 230. The second type of data 520 may include production volume information 240 and recipe information 250.

The restoration model 122 may be learned based on at least one of the correlation between the first type of data 510 and the operation data 210, the correlation between the second type of data 510 and the operation data 210, and the correlation between the operation data 210. For example, the restoration model 122 may learn the operation pattern of a semiconductor exposure device by using data in which data loss has not occurred among the operation data 210, in order to restore a part of the operation data 210, in which data loss has occurred. In some embodiments, the restoration model 122 may be implemented as a generative AI model with a multi-modal structure designed to process data from different domains, such as time series data and table data.

When loss operation data in which data loss has occurred is provided as an input value to the restoration model 122, the restoration model 122 may predict or identify a missing part of the loss operation data and supplement the part to output restoration operation data 530. In some embodiments, the restoration model 122 may include a generative AI model configured to restore lost data of the loss operation data to generate restoration operation data 530.

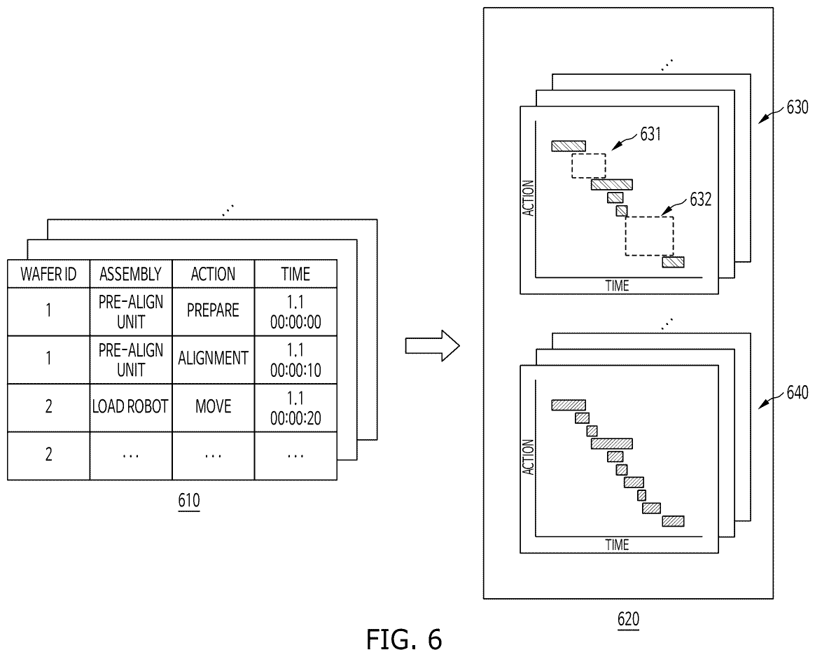

FIG. 6 is a diagram illustrating an exemplary process in which a loss operation is identified in operation data. In the following, any explanation that overlaps with the above description is omitted or briefly described.

Referring to the first example 610, the operation data of the semiconductor exposure device may be collected in the form of a table organized according to the time order in which a plurality of assemblies completed their operations. The operation data may include wafer information WAFER ID (e.g., wafer ID 1, wafer ID 2, etc.), assembly name ASSEMBLY (e.g., pre-align unit, load robot, etc.), operation name ACTION (e.g., prepare, alignment, move, etc.), and operation start time TIME, but the present disclosure is not limited thereto. For example, although not shown, operation data may further include operation end time, lot information, etc.

Referring to the second example 620, wafer operation data classified by wafer units may be obtained based on operation data. Wafer operation data may be classified for each wafer based on wafer information WAFER ID. For example, operation data may be classified into data having the same wafer information WAFER ID. Additionally, the operation data classified according to individual wafers may be time-series organized based on the operation time TIME. The graphs shown in the second example 620 may be examples of graphs where operation data related to the exposure process for individual wafers is time-series organized. In the graphs of the second example 620, the operation data (e.g., actions) may be defined along the Y-axis, and the time may be defined along the X-axis.

Afterwards, it may be identified whether data is missing based on the wafer operation data. Data identified as having loss operations 631 and 632 among wafer operation data may be classified as loss operation data 630, and data identified as not having a loss operation 631, 632 may be classified as non-loss operation data 640. For example, referring to the second example 620, in wafer operation data classified by individual wafers, if an operation log associated with a specific operation is identified as missing, loss operations 631 and 632 may be identified.

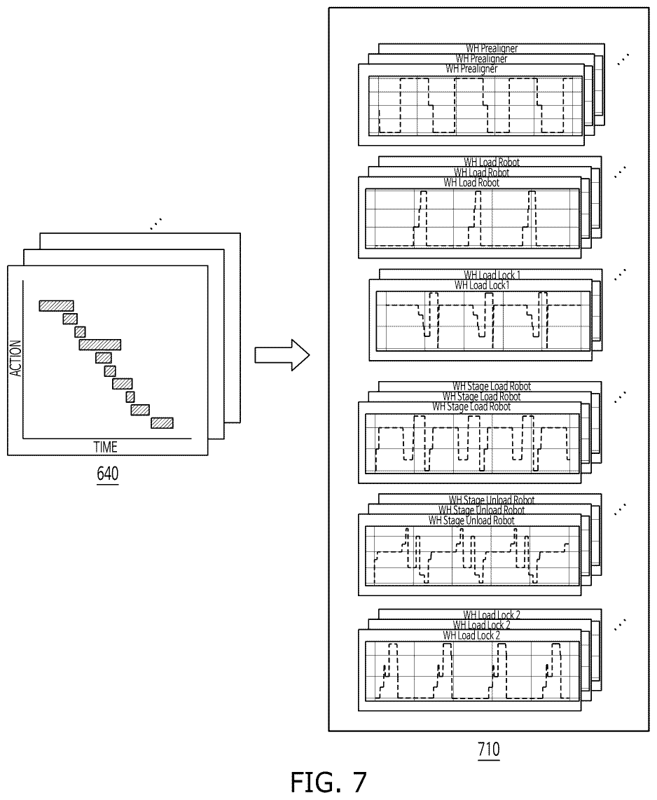

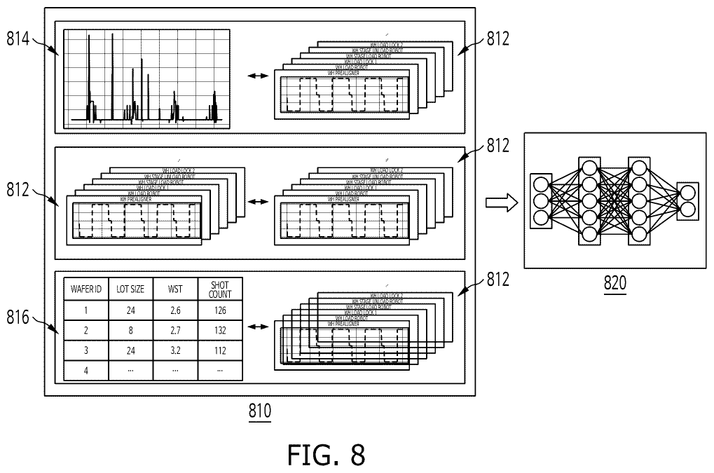

FIGS. 7 and 8 are diagrams for explaining an exemplary process in which a restoration model is learned. In the following, any explanation that overlaps with the above description is omitted or briefly described.

Referring to the first example 710 of FIG. 7, the non-loss operation data 640 is classified by assemblies, so that assembly operation data for each of a plurality of assemblies of the semiconductor exposure device may be obtained. In the first example 710, assembly operation data classified by six assemblies is shown, but the number of assembly operation data may be more or less than six depending on the number of assemblies included in the semiconductor exposure device. In the graphs illustrated in the first example 710, the horizontal axis may represent time, and the vertical axis may represent values mapped to unique operations of each assembly. Assembly operation data classified by assemblies may be provided for learning a restoration model.

Referring to the second example 810 of FIG. 8, at least one of the correlation between the first type of data 814 and the assembly operation data 812, the correlation between the second type of data 816 and the assembly operation data 812, and the correlation between the assembly operation data 812 may be analyzed and used for learning the restoration model 820. Here, the first type of data 814 may include at least one of error information and event information and may mean time series data. Additionally, the second type of data 816 may include at least one of production volume information and recipe information, and may mean data in the form of a table. The table showing the second type of data 816 may include, for example, wafer ID, lot size, wafer swap time (WST), and shot count.

In some embodiments, the restoration model 820 may include a machine learning model generated by machine learning based on a training data set. Here, a machine learning model may refer to any model that is used to infer an answer for a given input. According to one embodiment, the machine learning model may include, but is not limited to, an artificial neural network model including an input layer, a plurality of hidden layers, and an output layer.

In some embodiments, the restoration model 820 may be supervised-learned to infer lost data based on analyzed correlation information. For example, the first type of data, the second type of data, the non-loss operation data, correlation information, and loss operation data may be input to the restoration model 820, and the restoration operation data may be output. Loss may be calculated based on the output restoration operation data and non-loss operation data, and learning may be performed by adjusting the weights of the restoration model 820 so that the calculated loss is minimized. The above-described learning method is only an example, and any learning method such as unsupervised learning, self-supervised learning, reinforcement learning, or other types of supervised learning may be used to learn the restoration model 820. The restoration model 820 of FIG. 8 may correspond to the restoration model 122 of FIG. 3.

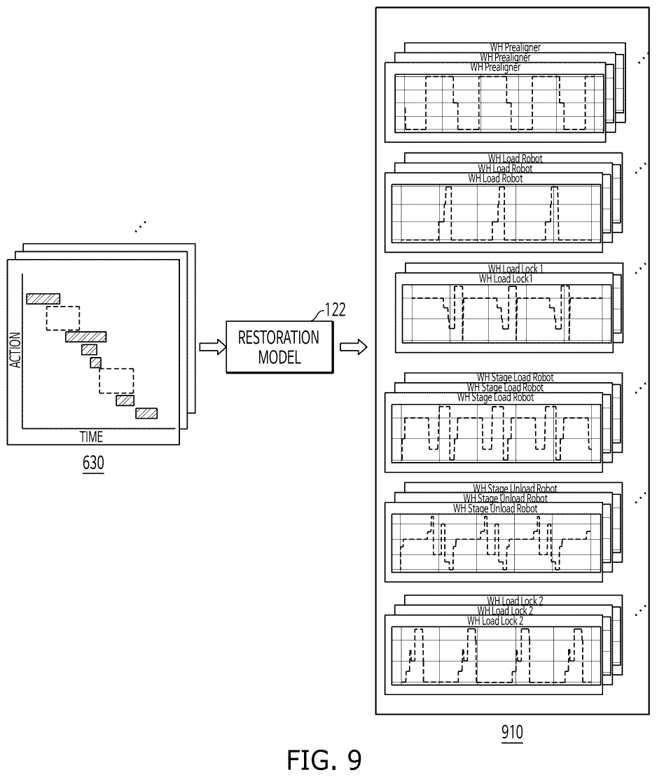

FIG. 9 is a diagram illustrating an exemplary process for obtaining restoration operation data through a restoration model. In the following, any explanation that overlaps with the above description is omitted or briefly described.

Referring to FIG. 9, the loss operation data 630 is provided as an input value to the restoration model 122, thereby obtaining the restoration operation data. For example, the restoration operation data may be obtained by restoring the loss operations 631 and 632 corresponding to the part where data loss occurred in the loss operation data 630 by the restoration model 122. Although not illustrated, as a preprocessing step before being provided to the restoration model 122, the loss operation data 630 may be classified by assemblies, similarly to what was described in FIG. 7. Alternatively, the loss operation data 630 may be provided to the restoration model 122 in a form classified by wafers, as illustrated.

Referring to the first example 910, the missing data of the loss operation data 630 is restored by the restoration model 122, so that the restoration operation data may be obtained. As illustrated, the restoration operation data may be in a form classified by assemblies.

FIG. 10 is a diagram illustrating an exemplary process for obtaining abnormal operation data. In the following, any explanation that overlaps with the above description is omitted or briefly described.

Referring to FIG. 10, reconstruction operation data 1030 may be obtained by providing operation data 1010 as input values to a reconstruction model 1020. Here, the operation data 1010 provided as an input value of the reconstruction model 1020 may be complete data with no missing data. For example, the operation data 1010 may include at least one of non-loss operation data in which no data loss occurred or restoration operation data in which data loss occurred but the lost portion was restored. The operation data 1010 may be classified according to individual wafers and provided to the reconstruction model 1020.

The reconstruction model 1020 may refer to a model configured to perform a process of compressing the features of input data, converting the compressed features into a low-dimensional latent representation, and then restoring it back into a form similar to the original data. The reconstruction model 1020 may learn statistical characteristics of data provided as input values and provide data that may serve as a reference for distinguishing between normal operation data 1060 and abnormal operation data 1050. Reconstruction model 1020 of FIG. 10 may correspond to reconstruction model 124 of FIG. 3.

The reconstruction model 1020 may statistically model normal operation patterns to minimize the difference between input data and output data by learning input operation data 1010. During the learning process, reconstruction operation data 1030 is generated based on the characteristics of normal data, and during this process, statistical indicators such as the mean, variance, and standard deviation of the data may be calculated. These indicators may be used to define normal ranges.

In some embodiments, the reconstruction model 1020 may be configured as an auto encoder including an encoder and decoder structure, but the embodiment is not limited to this example. Therefore, the reconstruction model 1020 may also be implemented as another form of neural network-based model.

The reconstruction model 1020 may calculate an error 1040 by calculating the difference between the input operation data 1010 and the reconstructed reconstruction operation data 1030. The generated error 1040 may be calculated through an indicator such as the mean squared error MSE, and may be used as a criterion for quantitatively evaluating how similar the reconstructed data is to the input data.

The reconstruction model 1020 may classify the operation data 1010 into abnormal operation data 1050 and normal operation data 1060 based on the generated error 1040. For example, if the generated error 1040 exceeds a predetermined threshold, the operation data 1010 may be classified as abnormal operation data 1050, and if the generated error 1040 is equal to or less than the threshold, the operation data 1010 may be classified as normal operation data 1060. Although FIG. 10 illustrates the threshold as being a discrete value, the threshold may be a range of values. When the threshold is a range of values, the operation data 1010 may be classified as abnormal operation data 1050 when the generated error 1040 is greater than a maximum value of the range of values or less than a minimum value of the range of values. And the operation data 1010 may be classified as normal operation data 1060 when the generated error 1040 is equal to or greater than the minimum value of the range of values and equal to or less than the maximum value of the range of values.

Specifically, if the mean value of the operation execution time associated with a specific assembly learned by normal operation data is 100 ms, and the standard deviation is 10 ms, and if the operation execution time associated with a specific assembly exceeds 130 ms or is less than 70 ms, the operation may be determined as an abnormal operation. Additionally, examples classified as abnormal behavior are not limited to this, and abnormal behavior may be classified based on various conditions. For example, the abnormal operation may be determined based on various conditions, such as when the time interval between operations between assemblies is abnormally increased, when operations associated with a specific assembly are performed in an unusual order, or when an unexpected abnormal operation is performed in the exposure process.

FIGS. 11 and 12 are diagrams for explaining an exemplary process in which a cause analysis model is generated based on abnormal operation data. In the following, any explanation that overlaps with the above description is omitted or briefly described.

Referring to FIG. 11, abnormal operation data 1050 may be clustered by operation patterns. In some embodiments, abnormal operation data 1050 may be provided as an input to a cluster model, and a plurality of sets of abnormal operation data may be provided as outputs of the cluster model. The cluster model may analyze abnormal operation data 1050 provided as input values, group data having the same or similar behavior patterns, and output them as individual abnormal operation data sets. Each of these clustered data may be inferred to be related to abnormal operations caused by similar causes.

Referring to the first example 1110, an example of a plurality of abnormal operation data sets obtained based on abnormal operation data 1050 is illustrated. Each of the four graphs 1112, 1114, 1116 and 1118 according to the first example 1110 may be an example of an abnormal operation data set representing an abnormal operation pattern. For example, the first graph 1112 may represent a case where the operation execution time of a specific assembly is abnormally increased, and the second graph 1114 may represent a case where the time interval of operations between assemblies is abnormally increased. The third graph 1116 may represent a case where the operation sequence of a particular assembly proceeds in an unusual manner, and the fourth graph 1118 may represent a case where an unexpected abnormal operation is performed in the exposure process.

Additionally, the abnormal operation data 1050 or a plurality of abnormal operation data sets may be provided to a user (e.g., an engineer) via the display 1120. For example, an abnormal operation data set for which the cause of the abnormal operation is not identified may be output through a display 1120, and a user may visually confirm the data set and then input related feedback data 1130. The input feedback data 1130 explains the cause of the abnormal operation pattern and may be used as a label together with the operation sequence and utilized as learning data for a cause analysis model. An advanced model, which may be flexibly applied to equipment and equipment models, may be constructed by reflecting the user's domain knowledge in the model learning process through a human-in-the-loop learning structure.

Referring to FIG. 12, a cause analysis model 126 may be learned based on abnormal operation data 1050 and feedback data 1130. The cause analysis model 126 may be configured to learn the correlation between the operation pattern included in the abnormal operation data 1050 and the cause of the abnormal operation included in the feedback data 1130. In addition, the cause analysis model 126 may extract an unidentified pattern whose cause has not been identified among the abnormal operation data 1050 and learn the cause of the abnormal operation related to the unidentified pattern based on the feedback data 1130 therefor. When new abnormal operation data 1050 is input during the learning process, the cause analysis model 126 analyzes the data to extract an unidentified pattern and learns it based on feedback data 1130, thereby enabling model performance to be continuously improved. Through this kind of iterative learning process, the cause analysis model 126 may be trained to more accurately predict the cause of abnormal operation and the subsequent follow-up measures.

Additionally, the learned cause analysis model 126 may be configured to predict the cause of abnormal operation based on abnormal operation data 1050 provided as input values and output follow-up measures therefor. For example, a cause analysis model 126 may predict that an abnormal time interval of a particular assembly is associated with an abnormal condition of a particular sensor and output an action which recommends inspection of the sensor. Through the learning and utilization process of this cause analysis model 126, the cause of abnormal operation may be identified more quickly and accurately, thereby maintaining facility stability and effectively improving productivity.

Additionally or alternatively, based on the follow-up actions for the cause of the abnormal operation which is output from the cause analysis model 126, the electronic device (e.g., electronic device 100 of FIG. 1) may be configured to transmit a control signal based on the analyzed cause of the abnormal operation, to the semiconductor exposure device (e.g., semiconductor exposure device 10 of FIG. 1) via a communication circuit (e.g., communication circuit 130 of FIG. 1). This enables an automated response to an abnormal operation, improving equipment stability and process efficiency.

According to various embodiments of the present disclosure, a system, which detects and analyzes the cause of abnormal operations by restoring and analyzing operation data based on generative AI of a multi-modal structure and user feedback. This system may be designed to learn basic cause analysis structures across various facilities, and even when new facilities are introduced, the existing model may be improved with only minimal additional learning such as fine-tuning based on the existing model. This enables a rapid response when changing facilities or introducing new facilities, and development time and costs may be effectively reduced.

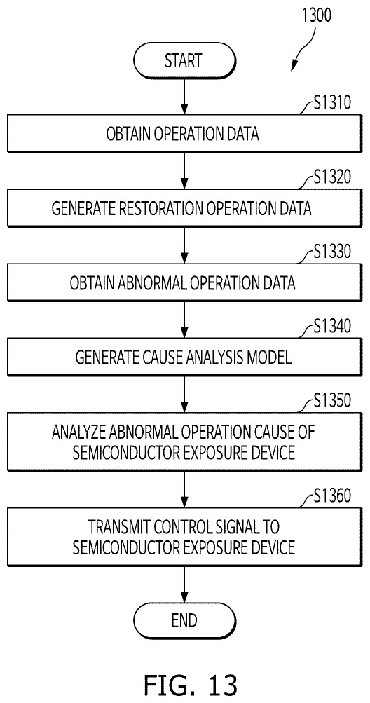

FIG. 13 is a flowchart illustrating an example of a method of operating an electronic device according to some example embodiments of the present disclosure. In some embodiments, the method 1300 may be performed by an electronic device (e.g., electronic device 100 of FIG. 1). In the following, any explanation that overlaps with the above description is omitted or briefly described.

Referring to FIG. 13, the electronic device may obtain operation data (e.g., operation data 210) through a communication circuit (e.g., communication circuit 130) included in the electronic device (S1310). The operation data may include data associated with the operation of a plurality of assemblies of a semiconductor exposure device in an exposure process for a wafer. For example, the operation data may include, but is not limited to, the name of the assembly, the operation name, the operation start time, the operation end time, wafer information, etc.

Additionally, the electronic device may generate restoration operation data (e.g., restoration operation data 530) by restoring lost data based on operation data (S1320). In some embodiments, the electronic device may identify a loss operation in which data loss occurred based on operation data, generate a restoration model for restoring the loss operation based on the operation data, and obtain restoration operation data associated with the loss operation using the restoration model.

In some embodiments, the operation data may be collected in a database (e.g., database 200) in a table format organized in the order of the performed operations, and transmitted to the electronic device. An electronic device may classify operation data in wafer units to obtain wafer operation data, and identify a loss operation for each wafer based on the obtained wafer operation data.

In some embodiments, the electronic device may obtain, via the communication circuitry (e.g., communication circuit 130), a first type of data (e.g., first type of data 510) associated with an operational event for a plurality of assemblies and a second type of data (e.g., second type of data 520) associated with execution of an exposure process. For example, the first type of data may include time series data recorded sequentially over time, and the second type of data may include, but is not limited to, data in the form of a table consisting of a plurality of rows and columns.

In some embodiments, the electronic device may train a restoration model (e.g., restoration model 122 of FIG. 3 or restoration model 820 of FIG. 8) based on the first type of data, the second type of data, and the operation data. For example, the electronic device may analyze at least one correlation among a correlation between the first type of data and the operation data, a correlation between the second type of data and the operation data, and a correlation between the operation data, and train a restoration model based on the analyzed at least one correlation. Here, the correlation between the operation data may mean the correlation between the first assembly operation data and the second assembly operation data included in the operation data.

Additionally, the electronic device may obtain abnormal operation data (e.g., abnormal operation data 1050) based on the restoration operation data (e.g., restoration operation data 530) (S1330). Abnormal operation data may include operation data for semiconductor exposure devices, which is operation data identified as an abnormal operation occurring in an exposure process for a unit wafer.

In some embodiments, the electronic device may obtain reconstruction operation data (e.g., reconstruction operation data 1030) by applying the restoration operation data to a reconstruction model (e.g., reconstruction model 124 of FIG. 3 or reconstruction model 1020 of FIG. 10), and classify abnormal operation data and normal operation data based on the reconstruction operation data. For example, the electronic device may calculate an error between the restoration operation data and the reconstruction operation data, and if the calculated error exceeds a predetermined threshold, the operation data may be identified as abnormal operation data.

Additionally, the electronic device may generate a cause analysis model (e.g., cause analysis model 126) for identifying the cause of abnormal operation for a plurality of assemblies of the semiconductor exposure device based on the abnormal operation data (S1340).

In some embodiments, the electronic device may output at least a part of the abnormal operation data via a display (e.g., display 140) and receive feedback data (e.g., feedback data 1130) related to the output data. For example, the electronic device may acquire a plurality of abnormal operation data sets by clustering abnormal operation data by operation patterns, and output at least some of the acquired plurality of abnormal operation data sets through a display. Here, at least some of the outputted plurality of abnormal operation data sets may be associated with, but are not limited to, unidentified patterns whose causes of the abnormal operation are not identified. The electronic device may learn a cause analysis model based on abnormal operation data and feedback data.

Additionally, the electronic device may analyze the cause of abnormal operation of the semiconductor exposure device based on the cause analysis model (S1350). Additionally, the electronic device may transmit a control signal to the semiconductor exposure device (e.g., semiconductor exposure device 10) through a communication circuit based on the analyzed cause of abnormal operation (S1360).

The flow chart illustrated in FIG. 13 and the description above are only examples, and some embodiments may be implemented differently. For example, in some embodiments, the order of each step may be changed, some steps may be repeated, some steps may be omitted, or some steps may be added. Additionally, at least one of the steps may be performed by a component other than an electronic device.

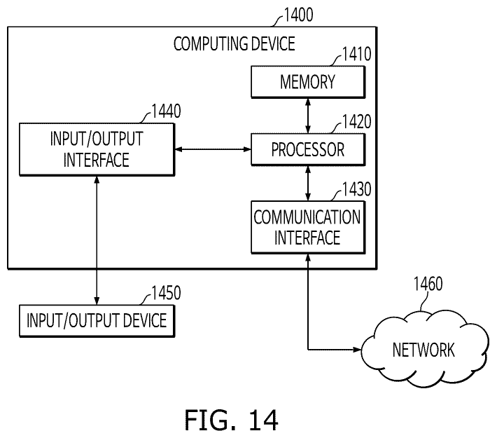

FIG. 14 is a drawing for explaining an example of a computer device in which an electronic device is implemented according to some embodiments of the present disclosure. In some embodiments, the electronic device 100 of FIG. 1 may be implemented by the computer device 1400 illustrated in FIG. 14.

Referring to FIG. 14, a computer device 1400 may include a memory 1410, a processor 1420, a communication interface 1430, and an input/output interface 1440.

The memory 1410 is a computer-readable recording medium and may include a random access memory RAM, a read only memory ROM, and a permanent mass storage device such as a disk drive. Additionally, an operating system and at least one program code may be stored in the memory 1410. These software components may be loaded into the memory 1410 from a computer-readable recording medium separate from the memory 1410. Such separate computer-readable recording media may include computer-readable recording media such as a hard disk, flash memory, an optical disk, an external hard disk, etc. Additionally, these software components may be loaded into memory 1410 via a communication interface 1430.

The processor 1420 may be configured to process instructions of a computer program by performing basic arithmetic, logic, and input/output operations. The commands may be provided to the processor 1420 by memory 1410 or a communication interface 1430.

The communication interface 1430 may provide a function for the computer device 1400 to communicate with other devices via a network 1460. The communication method is not limited, and the communication method may include not only a communication method utilizing a communication network (e.g., a mobile communication network, wired Internet, wireless Internet, or broadcasting network, etc.) that the network 1460 may include, but also short-range wireless communication between devices. For example, the network 1460 may include any one or more of networks such as a personal area network PAN, a local area network LAN, a campus area network CAN, a metropolitan area network MAN, a wide area network WAN, a broadband network BBN, and the Internet. Additionally, the network 1460 may include at least one of network topologies including, but not limited to, a bus network, a star network, a ring network, a mesh network, a star-bus network, a tree, or a hierarchical network.

The input/output interface 1440 may serve as an interface that may transmit commands or data, which are input from a user or an input/output device 1450, to other components of the computer device 1400. Additionally, the input/output interface 1440 may output commands or data received from other components of the computer device 1400 to a user or an input/output device 1450. For example, the input/output device 1450 may include an input device such as a microphone, a keyboard, or a mouse, and the output device may include an output device such as a display, a speaker, etc.

The above-described embodiments may be implemented in the form of a computer program that may be executed through various components on a computer, and such a program may be recorded on a computer-readable medium. At this time, the medium may include a magnetic medium such as a hard disk, a floppy disk or a magnetic tape, an optical recording medium such as a CD-ROM or DVD, a magneto-optical medium such as a floptical disk, and a hardware device specifically configured to store and execute program instructions, such as a ROM, a RAM, a flash memory, etc.

The above preferred embodiments of the present disclosure have been disclosed for the purpose of illustration, and those skilled in the art with common knowledge of the present disclosure will be able to make various modifications, changes, and additions within the spirit and scope of the present disclosure, and such modifications, changes, and additions should be considered to fall within the scope of the patent claims.

Those skilled in the art will appreciate that various substitutions, modifications, and changes may be made without departing from the technical spirit of the present disclosure, and therefore the present disclosure is not limited to the above-described embodiments and the attached drawings.

1. An electronic device comprising:
a communication circuit;
at least one processor; and
a memory,
wherein the memory stores instructions, when executed by the at least one processor, which cause the electronic device to:
obtain operation data associated with operations of a plurality of assemblies of a semiconductor exposure device in an exposure process for a wafer, through the communication circuit;
identify a loss operation associated with data loss based on the operation data;
generate a restoration model configured to restore the loss operation based on the operation data; and
obtain restoration operation data associated with the loss operation based on the restoration model.

2. The electronic device as claimed in claim 1, wherein the memory further stores instructions, when executed by the at least one processor, which cause the electronic device to:
obtain a first type of data associated with an operation event of the plurality of assemblies, through the communication circuit;
obtain a second type of data associated with an execution of the exposure process, through the communication circuit; and
train the restoration model based on the first type of data, the second type of data, and the operation data.

3. The electronic device as claimed in claim 2, wherein the memory further stores instructions, when executed by the at least one processor, which cause the electronic device to:
obtain assembly operation data for each of the plurality of assemblies based on the operation data, wherein the assembly operation data comprises first assembly operation data associated with a first assembly among the plurality of assemblies and second assembly operation data associated with a second assembly among the plurality of assemblies;
analyze at least one of a correlation between the first type of data and the assembly operation data, a correlation between the second type of data and the assembly operation data, or a correlation between the first assembly operation data and the second assembly operation data; and
train the restoration model based on the at least one analyzed correlation.

4. The electronic device as claimed in claim 3, wherein the memory further stores instructions, when executed by the at least one processor, which cause the electronic device to:
classify the operation data by the plurality of assemblies; and
convert the operation data, classified by the plurality of assemblies, into time series data.

5. The electronic device as claimed in claim 2,
wherein the first type of data comprises time series data recorded sequentially over time, and
wherein the second type of data comprises table data having a plurality of rows and columns.

6. The electronic device as claimed in claim 1, wherein the memory further stores instructions, when executed by the at least one processor, which cause the electronic device to:
obtain wafer operation data classified in wafer units based on the operation data; and
identify the loss operation corresponding to the wafer based on the obtained wafer operation data.

7. The electronic device as claimed in claim 6, wherein the memory further stores instructions, when executed by the at least one processor, which cause the electronic device to:
classify data, identified as having the loss operation among the wafer operation data, as loss operation data; and
classify data, identified as not having the loss operation among the wafer operation data, as non-loss operation data.

8. The electronic device as claimed in claim 1, wherein the restoration model comprises a generative artificial intelligence (AI) model configured to restore the loss operation of the operation data and generate the restoration operation data.

9. The electronic device as claimed in claim 1, wherein the memory further stores instructions, when executed by the at least one processor, which cause the electronic device to:
obtain abnormal operation data based on the restoration operation data; and
generate a cause analysis model configured to identify a cause of abnormal operations for the plurality of assemblies based on the abnormal operation data.

10. The electronic device as claimed in claim 9, wherein the memory further stores instructions, when executed by the at least one processor, which cause the electronic device to:
obtain reconstruction operation data based on a reconstruction model configured to reconstruct the restoration operation data;
calculate an error between the restoration operation data and the reconstruction operation data; and
identify the abnormal operation data based on the calculated error.

11. The electronic device as claimed in claim 10, wherein the memory further stores instructions, when executed by the at least one processor, which cause the electronic device to:
identify first operation data, in which the calculated error exceeds a threshold value, among operation data included in the restoration operation data, as the abnormal operation data.

12. The electronic device as claimed in claim 10, wherein the reconstruction model comprises an auto encoder.

13. The electronic device as claimed in claim 9,
wherein the electronic device further comprises a display, and
wherein the memory further stores instructions, when executed by the at least one processor, which cause the electronic device to:
output at least a part of the abnormal operation data to the display;
receive feedback data associated with the abnormal operation data; and
train the cause analysis model based on the abnormal operation data and the received feedback data.

14. The electronic device as claimed in claim 13, wherein the memory further stores instructions, when executed by the at least one processor, which cause the electronic device to:
obtain a plurality of abnormal operation data sets by clustering the abnormal operation data by operation patterns; and
output at least some of the plurality of abnormal operation data sets to the display.

15. The electronic device as claimed in claim 14, wherein the memory further stores instructions, when executed by the at least one processor, which cause the electronic device to:
extract an unidentified pattern based on the cause analysis model; and
output an abnormal operation data set associated with the extracted unidentified pattern to the display.

16. The electronic device as claimed in claim 9, wherein the memory further stores instructions, when executed by the at least one processor, which cause the electronic device to:
analyze a cause of an abnormal operation of the semiconductor exposure device based on the cause analysis model; and
transmit a control signal to the semiconductor exposure device based on the analyzed cause of the abnormal operation, through the communication circuit.

17. An electronic device comprising:
a communication circuit;
at least one processor; and
a memory,
wherein the memory further stores instructions, when executed by the at least one processor, which cause the electronic device to:
obtain operation data associated with operations of a plurality of assemblies of a semiconductor exposure device in an exposure process for a wafer, through the communication circuit;
obtain abnormal operation data based on the operation data;
generate a cause analysis model configured to identify a cause of abnormal operations for the plurality of assemblies based on the abnormal operation data;
output at least a part of the abnormal operation data;
receive feedback data associated with the abnormal operation data; and
train the cause analysis model based on the abnormal operation data and the received feedback data.

18. The electronic device as claimed in claim 17, wherein the memory further stores instructions, when executed by the at least one processor, which cause the electronic device to:
identify a loss operation associated with data loss based on the operation data;
generate a restoration model configured to restore the loss operation based on the operation data;
obtain restoration operation data associated with the loss operation based on the restoration model; and
obtain the abnormal operation data based on the restoration operation data.

19. The electronic device as claimed in claim 17, wherein the memory further stores instructions, when executed by the at least one processor, which cause the electronic device to:
obtain a plurality of abnormal operation data sets by clustering the abnormal operation data by operation patterns; and
output at least some of the plurality of abnormal operation data sets.

20. A method of operating an electronic device, the method comprising:
obtaining operation data associated with operations of a plurality of assemblies of a semiconductor exposure device in an exposure process for a wafer, through a communication circuit;
generating restoration operation data by restoring lost data based on the operation data;
obtaining abnormal operation data based on the restoration operation data; and
generating a cause analysis model configured to identify a cause of abnormal operations for the plurality of assemblies based on the abnormal operation data,
wherein the generating of the restoration operation data comprises:
identifying a loss operation associated with data loss based on the operation data;
generating a restoration model configured to restore the loss operation based on the operation data; and
obtaining the restoration operation data associated with the loss operation based on the restoration model.
